(19) United States
(12) Patent Application Publication
(10) Pub. No.: US 2018/0327227 A1
(43) Pub. Date: Nov. 15, 2018

(54) ROPE CLIMBING ELEVATOR SYSTEM

(71) Applicant: Otis Elevator Company, Farmington, CT (US)

(72) Inventors: Richard Hollowell, Georgetown, SC (US); Jianwei Zhang, Hangzhou (CN); Xing Mao, Hangzhou (CN)

(21) Appl. No.: 15/977,222

(22) Filed: May 11, 2018

(30) Foreign Application Priority Data
May 12, 2017 (CN) 201710332937.2

(51) Int. Cl. B66B 9/02; B66B 11/00

(52) U.S. Cl. CPC B66B 9/027; B66B 11/0035; B66B 11/008

(57) ABSTRACT

The present invention provides a rope climbing elevator system, and pertains to the technical field of elevator. The elevator system of the present invention can achieve a ratio of a linear rotation speed of a drive motor to a movement speed of an elevator car, larger than or equal to about 2:1, can lower the torque requirement for the drive motor, decrease the weight of the drive motor, and reduce the cost of the drive motor.

### FOREIGN PRIORITY

This application claims priority to Chinese Patent Application No. 201710332937.2, filed May 12, 2017, and all the benefits accruing therefrom under 35 U.S.C. § 119, the contents of which in its entirety are herein incorporated by reference.

### FIELD OF THE INVENTION

The present invention pertains to the technical field of elevator, relates to an elevator system with a self-climbing elevator car, especially to a rope climbing elevator system in which a ratio of a linear rotation speed of a drive motor to a movement speed of an elevator car is larger than or equal to about 2:1.

### BACKGROUND

The known elevator systems typically use ropes for climbing. Generally speaking, it is necessary to arrange a machine room to accommodate a drive device, such as a tractor, to pull the ropes, thereby hoisting an elevator car, thus it is necessary to leave corresponding space in a shaft (also named as hoistway) of a building for the machine room. Moreover, a counterweight is generally used to cooperate with vertically upward and downward movement of the elevator car in the shaft, thus it is necessary to arrange a counterweight rail in the shaft and leave corresponding space for the upward and downward movement of the counterweight.

U.S. Pat. No. 6,193,016B1 entitled “Dual Pulley Rope Climber Using Flat Flexible Ropes” by Richard L. Hollowell et al. unveils a rope climbing elevator system, which is a no-counterweight elevator system. In the elevator system described by U.S. Pat. No. 6,193,016B1, self-climbing of the elevator car is accomplished by a drive motor mounted to the elevator car and a double-groove pulley, at a ratio of a linear rotation speed of the drive motor to a movement speed of the elevator car, equal to 1:1.

### SUMMARY OF THE INVENTION

According to one aspect of the present invention, it provides a rope climbing elevator system, comprising: an elevator car, which can move along an up-down direction; one or more host upper diverter pulleys, which are fixedly arranged above the elevator car; one or more tensioners, which are located below the elevator car; one or more host lower diverter pulleys, which are fixed to the tensioners; one or more ropes; and a counter-rotating paired drive pulley, which is fixed to the elevator car and comprises a first drive pulley and a second drive pulley that are adapted to engage with the ropes; wherein a ratio of a linear speed of the first drive pulley and the second drive pulley to a movement speed of the elevator car is about X:1 in the climbing process, X is larger than or equal to 2, X optionally can be an integer.

According to another aspect of the present invention, it provides a rope climbing elevator system, comprising: a plurality of elevator cars, which are arranged in a single shaft and can move along an up-down direction; and one or more tensioners, which are located below said plurality of elevator cars (110); wherein each of said plurality of elevator cars is provided with: one or more ropes for hoisting each of said plurality of elevator cars; one or more host upper diverter pulleys, which are fixedly arranged above each of said plurality of elevator cars; one or more host lower diverter pulleys, which are fixed to the tensioners; and a counter-rotating paired drive pulley, which is fixed to each of said plurality of elevator cars and comprises a first drive pulley and a second drive pulley that are adapted to engage with the ropes; wherein a ratio of a linear speed of the first drive pulley and the second drive pulley to a movement speed of the corresponding elevator car is about X:1 in the climbing process, X is larger than or equal to 2, X optionally can be an integer; and the ropes for each of said plurality of elevator cars does not interfere with other ropes for other elevator cars.

According to the following depiction and drawings, the above features and operations of the present invention will become more obvious.

### BRIEF DESCRIPTION OF THE DRAWINGS

The explanations elaborated below with reference to the drawings will make the above and other objects and advantages of the present invention more complete and clear, wherein identical or similar elements are denoted by identical reference signs.

FIG. 1 is a schematic diagram of an elevator system according to a first embodiment of the present invention.

FIG. 2 is a schematic diagram of an elevator system according to a second embodiment of the present invention.

FIG. 3 is a bottom view of a paired drive pulley in an elevator system as shown in FIG. 1.

FIG. 4 is a schematic diagram of an elevator system according to a third embodiment of the present invention.

FIG. 5(a) shows a rope(s) 130 arranged to correspond to an elevator car 110a according to a fourth embodiment of the present invention; FIG. 5(b) shows a rope(s) 130 arranged to correspond to an elevator car 110b according to a fourth embodiment of the present invention.

FIGS. 6(a) and 6(b) are bottom views of an elevator system according to a fourth embodiment of the present invention.

FIG. 7 is a schematic diagram of an elevator system according to a fifth embodiment of the present invention.

FIG. 8(a) shows ropes arranged to correspond to an elevator car 110a according to a sixth embodiment of the present invention; FIG. 8(b) shows ropes arranged to correspond to an elevator car 110b according to a sixth embodiment of the present invention.

FIG. 9(a) is a schematic diagram of arrangement of a host upper diverter pulley in an elevator system 60 according to a sixth embodiment of the present invention; FIG. 9(b) is a schematic diagram of arrangement of a host lower diverter pulley in an elevator system 60 according to a sixth embodiment of the present invention.

FIG. 10(a) is a schematic diagram of arrangement of the paired drive pulleys on an elevator car 110a according to a sixth embodiment of the present invention; FIG. 10(b) is a schematic diagram of arrangement of the paired drive pulleys on an elevator car 110b according to a sixth embodiment of the present invention.

FIG. 11 is a schematic diagram of an elevator system according to a seventh embodiment of the present invention.

FIG. 12 is a schematic diagram of an elevator system according to an eighth embodiment of the present invention.

FIG. 13 is a schematic diagram of an elevator system according to a ninth embodiment of the present invention.

### DETAILED DESCRIPTION OF THE INVENTION

The present invention will be described herein in a more complete way with reference to the drawings. Exemplary embodiments of the present invention are shown in the drawings, but the present invention may be implemented in many different forms and it shall not be construed to be limited to the embodiments described herein. On the contrary, the embodiments are provided to make the disclosure thorough and complete and to convey the idea of the present invention fully to those skilled in the art.

In the following depiction, the direction corresponding to “up-down direction” is defined with respect to the movement direction of the elevator car of the elevator system, the direction corresponding to “left-right direction” is defined with respect to the open or close direction of the car door of the elevator car of the elevator system, and the direction corresponding to “front-back direction” is a direction perpendicular to the up-down direction and the left-right direction. Directional terms (such as “up”, “down”, “left”, “right”, “front”, “back”) and similar terms are used to describe various implementation manners and components of the implementation manners. These directional terms correspond to directions shown in the drawings or directions that can be understood by those skilled in the art.

In the following depiction, when it is alleged that a component is “fixed” to another component, it may be directly fixed to another component or may be indirectly fixed to another component through an intermediate component. On the contrary, when it is alleged that a component is “directly fixed” to another component, an intermediate component does not exist.

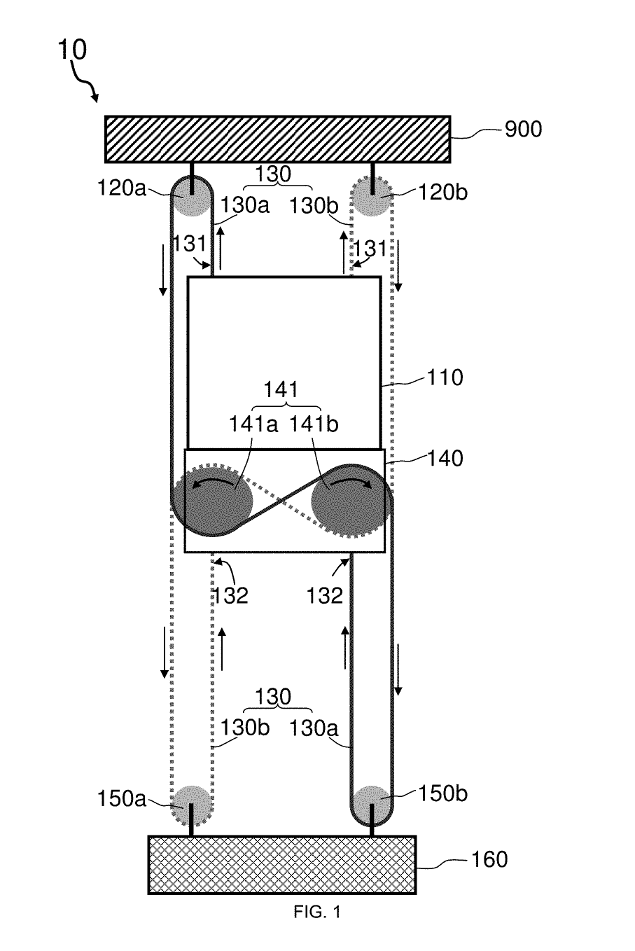

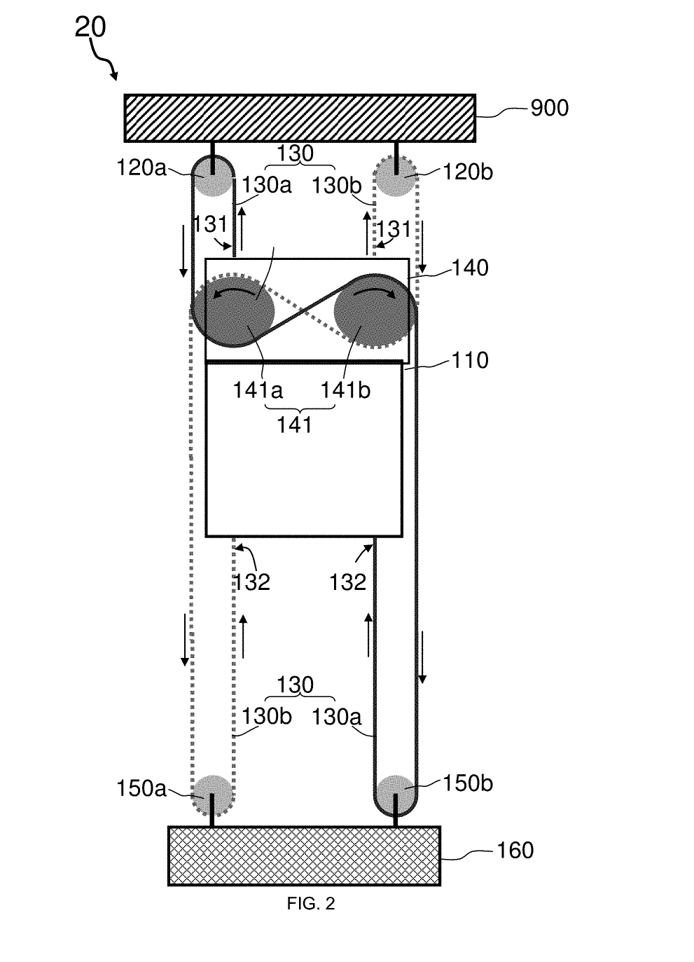

FIG. 1 is a schematic diagram of an elevator system according to an embodiment of the present invention. FIG. 2 is a schematic diagram of an elevator system according to another embodiment of the present invention. An elevator system 10 and an elevator system 20 are rope climbing elevator systems, and they have a basically identical working principle. It should be explained that the elevator system 20 in the embodiment shown in FIG. 2 provides a case of an alternative embodiment different in the position of a paired drive pulley 141 of the elevator system 10 with respect to an elevator car 110 in the embodiment shown in FIG. 1, and the arrangement or configuration of other components in the elevator system 20 remains basically identical. Therefore, in the following depiction, the elevator systems in the embodiments as shown in FIG. 1 and FIG. 2 are illustrated together.

As shown in FIG. 1 and FIG. 2, the elevator car 110 in the elevator system 10 or 20 can move up and down, thereby carrying passengers to different floors. The elevator car 110 is arranged in the shaft (also named as “hoistway”, not shown in the figures), and there is no limitation to the specific structure of the shaft.

A rope(s) 130 in the elevator system 10 or 20 is a pull member or a traction medium, and can directly pull the elevator car 110 to move in the shaft. The action that the rope(s) 130 pulls the elevator car 110 is controlled by a propulsion device 140 in the elevator system 10 or 20. The propulsion device 140 is controlled by a control module (not shown in the figures) of the elevator system 10 or 20. To be specific, the rope(s) 130 may be a flexible pull member adaptable to bend. According to the specific application conditions and performance requirements of the elevator system 10 or 20, the structure and/or material type of the rope(s) 130 may be arranged specifically.

The propulsion device 140 in the elevator system 10 or 20 is fixed on the elevator car 110. In an embodiment, as shown in FIG. 1, the propulsion device 140 is integrally fixed below a bottom of the elevator car 110. In an alternative embodiment, the propulsion device 140 is integrally fixed above top of the elevator car 110. In the process of the movement of the elevator car 110, the propulsion device 140 supplies power to the elevator car 110. The propulsion device 140 moves up and down in sync with the elevator car 110. As such, in fact, the propulsion device 140 drives itself to move in the shaft. Therefore, the elevator system 10 or 20 can bring it about that the elevator car 110 is self-driven.

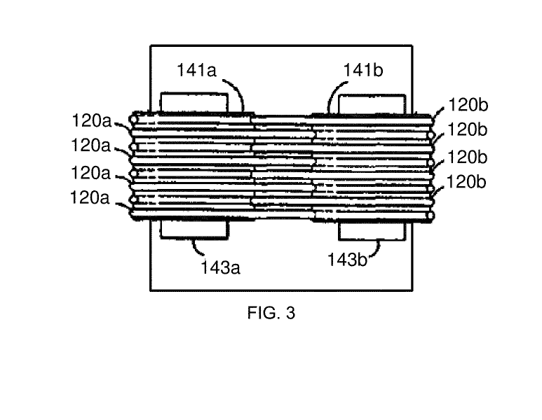

Specifically speaking, as shown in FIG. 3, the propulsion device 140 mainly comprises a counter-rotating paired drive pulley 141 and drive motors 143. The paired drive pulley 141 comprises a drive pulley (or called as a traction pulley) 141a and a drive pulley 141b. A drive motor 143a and a drive motor 143b are arranged to correspond to the drive pulley 141a and the drive pulley 141b respectively. During operation, the drive motor 143a and the drive motor 143b, arranged in parallel, rotate in opposite directions, thereby driving the drive pulley 141a and the drive pulley 141b, arranged in parallel, to rotate in opposite directions.

It is noted that that “counter-rotating” in the counter-rotating paired drive pulley means that two paired drive pulleys (141a and 141b) rotate simultaneously in opposite directions, such that the rope(s) 130 wrapping around the two drive pulleys 141a and 141b can move in a single direction. Moreover, it can be determined that when the elevator car 110 moves up and down in the shaft, host upper diverter pulleys 120a and 120b rotate in opposite directions, and host lower diverter pulleys 150a and 150b also rotate in opposite directions.

In an embodiment, the drive pulley 141a and the drive pulley 141b are grooved sheaves that have a plurality of grooves for engaging with the rope 130, and on the drive pulley 141a and the second drive pulley 141b of each of the paired drive pulley 141, different grooves are allocated to engage with the rope 130a and the rope 130b correspondingly.

With continued reference to FIG. 1 and FIG. 2, the elevator system 10 or 20 is further provided with a tensioner 160, which is located below the elevator car 110. To be specific, for instance, it may be arranged at the bottom of the shaft where the elevator car 110 is, with no influence or restriction on the space where the elevator car 110 moves (the elevator car 110 can move between the tope and the bottom of the shaft), and it occupies a little space in the shaft. On its surface facing the elevator car 110, the tensioner 160 is provided with a host lower diverter pulley 150. In an embodiment, there are two host lower diverter pulleys 150, i.e., a host lower diverter pulley 150a and a host lower diverter pulley 150b, wherein the host lower diverter pulley 150a is arranged to substantially correspond to the left edge of the elevator car 110, and the host lower diverter pulley 150b is arranged to substantially correspond to the right edge of the elevator car 110. To be specific, the host lower diverter pulley 150a and the host lower diverter pulley 150b are basically identical, e.g., they have a basically identical structure (e.g., they have identical diameter), and are made of a basically identical material, and they are arranged substantially in bilateral symmetry.

With continued reference to FIG. 1 and FIG. 2, the elevator system 10 or 20 is further provided with host upper diverter pulleys 120, which is fixedly arranged above the elevator car 110, e.g., it may be fixedly arranged on a building member 900 on the top of the shaft, such that it can hang in the shaft main components of the elevator system 10 or 20 of the embodiments of the present invention. In an embodiment, there are two host upper diverter pulleys 120, i.e., a host upper diverter pulley 120a and a host upper diverter pulley 120b, wherein the host upper diverter pulley 120a is arranged to substantially correspond to the left edge of the elevator car 110, and the host upper diverter pulley 120b is arranged to substantially correspond to the right edge of the elevator car 110, such that the elevator car 110 is hanged in balance and pulled in balance in a left-right direction. To be specific, the host upper diverter pulley 120a and the host upper diverter pulley 120b are basically identical, e.g., they have a basically identical structure (e.g., they have an identical diameter), and are made of a basically identical material, and they are arranged in substantially bilateral symmetry. Further, the host upper diverter pulley 120a and the host lower diverter pulley 150a can be substantially arranged on a straight line in an up-down direction, and the host upper diverter pulley 120b and the host lower diverter pulley 150b can be substantially arranged on a straight line in an up-down direction, which is conducive to improvement in the balance and stability of the elevator car 110 during movement.

The diverter pulleys (such as the host upper diverter pulley 120 and the host lower diverter pulley 150) in the above embodiments are configured to adapt to engage with the rope(s) 130, and driven by the rope 130, rotate. The diverter pulleys can make the rope 130, which wraps around them, turn substantially 180 degrees. Thus, the rope(s) 130 wraps around the diverter pulleys by substantially covering 180-degree arc surfaces of the diverter pulleys (such as the host upper diverter pulley 120 and the host lower diverter pulley 150). To be specific, the rope(s) 130 substantially covers the diverter pulleys.

With continued reference to FIG. 1 and FIG. 2, the ropes 130 can be set as two group, for example a rope 130a and a rope 130b. It is noted that that the rope 130a and the rope 130b may be one rope, or may be one cluster of ropes arranged in parallel, without limitation on the number. Each rope 130a or rope 130b has two ends, i.e., a first end 131 and a second end 132, wherein the first end 131 and the second end 132 are directly or indirectly fixed on the elevator car 110. To distinguishing the rope 130a from the rope 130b, the rope 130b is denoted by a dash-dotted line in the figures. The specific arrangement manners of the rope 130a and the rope 130b are explained below.

Regarding the rope 130a, the first end 131 of the rope 130a is fixed to correspond to the left edge of the elevator car 110, e.g., it is fixed near the left edge of the top of the elevator car 110 as shown in FIG. 1, extends vertically upward and wraps partially around the host upper diverter pulley 120a, bends about 180 degrees to extend vertically downward, further wraps partially around the low portion of the drive pulley 141a, extends substantially obliquely upward and wraps partially around the top portion of the drive pulley 141b, bends substantially vertically to extend downward, then wraps around the host lower diverter pulley 150b, bends about 180 degrees to extend vertically upward to the second end 132 of the rope 130a; the second end 132 of the rope 130a is fixed to correspond to the right edge of the elevator car 110, e.g., it is fixed on the propulsion device 140 (when the propulsion device 140 is fixed below the exterior bottom of the elevator car 110).

The rope 130b is arranged in a substantially identical manner as the rope 130a. The rope 130a is arranged substantially in bilateral symmetry with the rope 130b. To be specific, as for the rope 130b, the first end 131 of the rope 130b is fixed to correspond to the right edge of the elevator car 110, e.g., it is fixed near the right edge of the top of the elevator car 110 as shown in FIG. 1, extends vertically upward and wraps partially around the host upper diverter pulley 120b, bends about 180 degrees to extend vertically downward, further wraps partially around the low portion of the drive pulley 141b, extends substantially obliquely upward and wraps partially around the top portion of the drive pulley 141a, bends substantially vertically to extend downward, then wraps around the host lower diverter pulley 150a, bends about 180 degrees to extend vertically upward to the second end 132 of the rope 130b; the second end 132 of the rope 130b is fixed to correspond to the left edge of the elevator car 110, e.g., it is fixed on the propulsion device 140 (when the propulsion device 140 is fixed below the exterior bottom of the elevator car 110).

It should be explained that when the rope 130a wraps around the host upper diverter pulley 120a, the rope 130a basically covers the arc surface of the upper half part of the host upper diverter pulley 120a and engages with it. Likewise, when the rope 130b wraps around the host upper diverter pulley 120b, the rope 130b basically covers the arc surface of the upper half part of the host upper diverter pulley 120b and engages with it. In this way, during operation, a static friction force is generated between the rope and the host upper diverter pulley to drive the host upper diverter pulley to rotate. The magnitude of the maximum static friction force between the rope(s) 130 and the host upper diverter pulley 120 is relevant to the weight of the elevator car 110 (including the weight of passengers), the weight of the propulsion device 140, the weight of the tensioner 160, the structure and friction coefficient of the arc surface of the host upper diverter pulley, the structure and material of the rope, etc.

Likewise, when the rope 130a wraps around the host lower diverter pulley 150b, the rope 130a basically covers the arc surface of the lower half part of the host lower diverter pulley 150b and engages with it. Likewise, when the rope 130b wraps around the host lower diverter pulley 150a, the rope 130b basically covers the arc surface of the lower half part of the host lower diverter pulley 150a and engages with it. In this way, during operation, a static friction force is generated between the rope and the host lower diverter pulley to drive the host lower diverter pulley to rotate. The magnitude of the maximum static friction force between the rope(s) 130 and the host lower diverter pulley 150 is relevant to the weight of the tensioner 160, the structure and friction coefficient of the arc surface of the host lower diverter pulley 150, the structure and material of the rope, etc.

When the rope 130a wraps around the low portion of the drive pulley 141a, the rope 130a covers part of the arc surface of the lower half part of the drive pulley 141a and engages with it. When the rope 130a wraps around the top portion of the drive pulley 141b, the rope 130a covers part of the arc surface of the upper half part of the drive pulley 141b and engages with it. In this way, during operation, the maximum static friction force is generated between the rope 130a and the drive pulleys 141a and 141b. The torque of the drive pulleys 141a and 141b is conveyed through the maximum static friction force. The drive pulleys 141a and 141b together pull the rope 130a to move in a predetermined direction.

Likewise, when the rope 130b wraps around the drive pulley 141b, the rope 130b covers part of the arc surface of the lower half part of the drive pulley 141b and engages with it. When the rope 130b wraps around the drive pulley 141a, the rope 130b covers part of the arc surface of the upper half part of the drive pulley 141a and engages with it. In this way, during operation, the maximum static friction force is generated between the rope 130b and the drive pulleys 141a and 141b. The torque of the drive pulleys 141a and 141b is conveyed through the maximum static friction force. The drive pulleys 141a and 141b together pull the rope 130b to move in a predetermined direction.

The magnitude of the maximum static friction force between the rope(s) 130 and the drive pulley 141 is relevant to the tensile force of the rope 130, the weight of the tensioner 160, the structure and friction coefficient of the arc surface of the drive pulley 141, the structure and material of the rope, etc.

The basic working principle of the elevator system 10 or 20 is illustrated below.

With reference to FIG. 1 and FIG. 2, driving the elevator car 110 to move vertically upward in the shaft is taken as an example. Driven by the drive motors 143a and 143b, the drive pulley 141a rotates anticlockwise as shown in the figures, and the drive pulley 141b rotates clockwise as shown in the figures. The ropes 130a and 130b are pulled in the directions of the arrows shown in the figures. Suppose the first ends 131 of the ropes 130a and 130b pull the elevator car 110 upward for a distance D, then the second ends 132 of the ropes 130a and 130b also move synchronously upward for a distance D. Thus, in fact, the ropes 130a and 130b move for a distance 2D, i.e., the drive pulleys 141a and 141b rotate circumferentially for a distance 2D. In this way, the ratio of the linear rotation speed of the drive motors 143a and 143b to the upward movement speed of the elevator car 110 is about 2:1.

On the basis of a substantially identical transmission principle, when the elevator car 110 is driven to move down in the shaft, the ratio of the linear rotation speed of the drive motors 143a and 143b to the downward movement speed of the elevator car 110 is about 2:1.

Therefore, in the elevator system 10 or 20 of the above embodiments, the torque requirement for the drive motors 143a and 143b can be lowered, especially in the process of driving the elevator car 110 to move up (upward movement has a higher torque requirement for the drive pulleys). In other words, under the conditions of the identical weight of the elevator car (including the weight of the car, car frame, load, etc.) and the identical movement speed, the requirement for the torque output by the drive motors 143a and 143b is lowered. Further, under the circumstance of lowering the torque requirement, the weight of the drive motors 143a and 143b in the propulsion device 140 can also be decreased, and the cost can also be reduced. Moreover, it should be noted that as the propulsion device 140 like the drive motors 143a and 143b is fixed on the elevator car 110 and moves in sync with the elevator car 110, the decreased weight of the drive motors 143a and 143b is conducive to power consumption reduction, and further lowers the torque requirement for the drive motors 143a and 143b.

It should be understood that as the torque requirement for the drive motors 143 is lowered in the elevator system 10 or 20 of the above embodiments, in the case of the identical torque output, the elevator car 110 with a larger rated load can be driven to move in the shaft. Therefore, it is conducive to an increase in the rated load of the elevator car 110.

It should be understood that the main function of the tensioner 160 in the above embodiments is to apply a downward force to the host lower diverter pulley 150. The force serves to tension the ropes 130a and 130b, especially to tension part of the ropes 130a and 130b below the drive pulleys 141a and 142b, thereby avoiding relative slip between the drive pulleys 141a, 142b and each rope 130, especially in the movement of the elevator car 110. In this way, the torque output by the drive motors 143 and the drive pulley 141 can be conveyed effectively to move the elevator car 110 effectively.

The relative slip between the drive pulleys 141a, 142b and each rope(s) 130 can be avoided by increasing the static friction force between the drive pulley 141 and each rope(s) 130 effectively. In an embodiment, it is accomplished by arranging the magnitude of the downward force that the tensioner 160 applies to the host lower diverter pulley 150. For instance, when the tensioner 160 is realized by a component similar to a counterweight, according to the maximum torque required to be output by the drive motors 143, the slip is avoided by arranging the weight of the tensioner 160. In another embodiment, a flat rope is used as the ropes 130a and 130b, because the flat rope is a component that has a width value, in a first direction, of its cross section perpendicular to its lengthwise direction greater than a thickness value thereof in a second direction, wherein the first direction is substantially perpendicular to the second direction. The surface of the flat rope with a relatively greater width value corresponds to and engages with the arc surfaces (such as arc groove faces) of the drive pulleys 141a and 141b, increasing the area of engagement effectively, thereby increasing the maximum static friction force therebetween.

It is noted that that the tensioner 160 mainly serves to apply a downward force to the host lower diverter pulley 150. Corresponding to the ropes 130a and 130b, the tensioner 160 may be arranged integrally, and may also be arranged separately. For instance, the tensioner 160 is arranged for each rope 130a or 130b separately; the tensioner may also be any other known or unknown components that can apply the downward force, such as spring and actuator.

In an embodiment, when the elevator car is static (for instance, it stops at a certain floor), the drive motors 143a and 143b are braked; accordingly, the drive pulleys 141a and 141b are also braked. At the moment, the downward tensile force applied by the gravity of the elevator car among others to the ropes 130a and 130b needs to be less than the maximum static friction force between the drive pulleys 141a, 141b and each rope 130, such that the ropes 130a and 130b will not slip with respect to any drive pulley, and the elevator car 110 keeps static. When the elevator car is static, the relative slip between the drive pulleys 141a, 142b and each rope(s) 130 can be avoided by arranging the tensioner 160 to apply a downward force to the host lower diverter pulley 150, such that the elevator car 110 can be stopped by just braking the drive motors 143a and 143b.

With continued reference to FIG. 1 and FIG. 2, when the elevator car 110 moves down in the shaft, the tensioner 160, distinguishing from the traditional counterweight, also basically keeps static with respect to the elevator car 110. The elevator car 110 can drive itself to move down under its own gravity. At the moment, the tensile force that the elevator car 110 conveys to the rope(s) 130 can drive the drive pulleys 141a and 141b to rotate in opposite directions. In an embodiment, the drive motors 143a and 143b can be enabled to generate electricity to recover energy, and therefore are more energy-efficient. The downward movement speed of the elevator car 110 can be controlled by controlling the linear rotation speed of the drive motors 143a and 143b.

It should be understood that the elevator system 10 or 20 of the above embodiments has one or more advantages as follows.

The machine roomless arrangement is accomplished by mounting the propulsion device 140, which comprises the paired drive pulley 141 and the drive motors 143, above the exterior top of the elevator car 110 or below the exterior bottom thereof, preventing the machine room and the like from occupying the space of the shaft.

The tensioner 160 is completely distinct from a traditional counterweight that moves up and down together with the elevator car. Thus, the elevator system 10 or 20 also has some advantages of no-counterweight elevator systems. For instance, it is free of arrangement such as a rail for the movement of the counterweight, and additional space for the movement of the counterweight in the shaft.

Each rope(s) 130 is arranged to make small a tension difference, caused by the gravity of the rope, between two rope sections on two sides of the host upper diverter pulley 120, and make small a tension difference, caused by the gravity of the rope, between two rope sections on two sides of the host lower diverter pulley 150. Thus, it is adapted to be applied on the occasion of climbing for a relatively greater height, such as greater than or equal to 100 m, or greater than or equal to 200 m, or greater than or equal to 300 m.

As can be learned from items (a) and (b), the elevator system 10 or 20 has a low requirement for the space of the shaft, and can be arranged in a building more flexibly.

With continued reference to FIG. 3, the spin axes of the drive pulleys 141a and 141b in the paired drive pulley 141 are arranged in parallel. The drive pulleys 141a and 141b can have the identical configurations (such as identical diameter, identical number of grooves, identical material, etc.). The drive motors 143a and 143b can be arranged in an identical way except different linear rotation speeds (such as identical power output, identical torque output, etc.). On each drive pulley 141, different grooves are allocated to engage with the ropes 130a and 130b. The diameter of the drive pulleys 141a and 141b and the distance therebetween can be arranged according to practical applications. In an embodiment, the distance between the drive pulley 141a and the drive pulley 141b and/or the radius thereof are/is arranged to avoid interference between the rope(s) 130 and the side faces of the elevator car 110. In this way, in the process of the upward and downward movement of the elevator car 110, parts of the rope 130, which pass through the side faces of the elevator car 110, will not interfere with the elevator car 110.

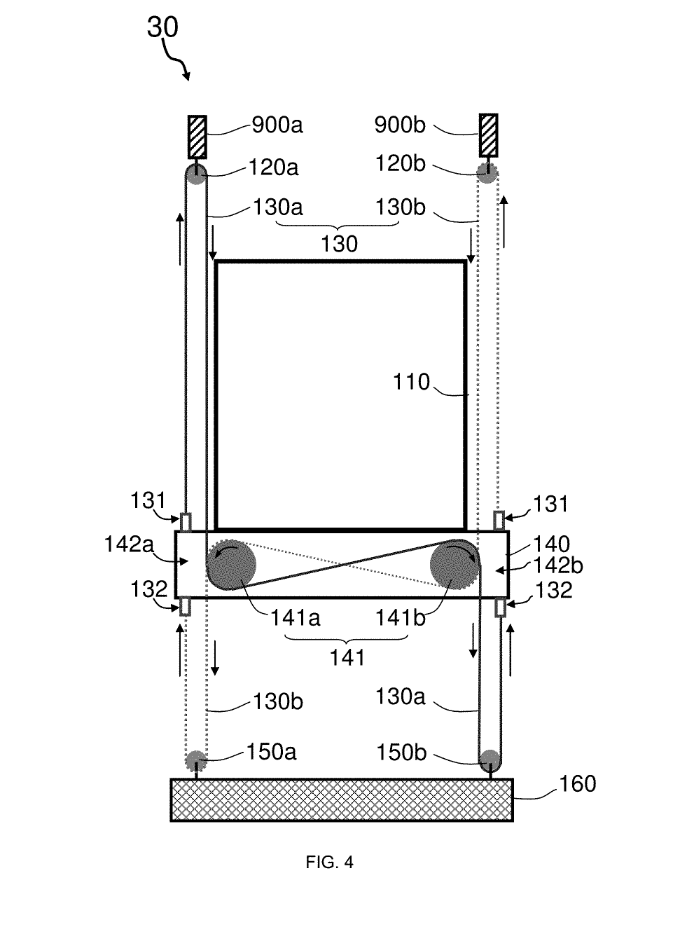

FIG. 4 is a schematic diagram of an elevator system according to a third embodiment of the present invention. The elevator system 30 also comprises components similar to the elevator car 110 and the tensioner(s) 160 in the elevator system 10, and further comprises one or more components as follows: the propulsion device 140; the paired drive pulley 141 in the propulsion device 140, which comprises the drive pulley 141a and the drive pulley 141b; host upper diverter pulleys 120a and 120b; host lower diverter pulleys 150a and 150b; and ropes 130a and 130b.

The arrangement of the above components is substantially identical with that of the corresponding components in the elevator system 10. Therefore, the specific depiction of the identical arrangement is omitted herein, and the main differences between the components in the elevator system 30 and the components in the elevator system 10 are elaborated below.

As shown in FIG. 4, the size of the propulsion device 140 is larger than that of the elevator car 110 in the left-right direction. In other words, the propulsion device 140 has a protrusion portion that protrudes towards the left with respect to a left side of the elevator car 110, i.e., a left protrusion portion 142a, and a protrusion portion that protrudes towards the right with respect to a right side of the elevator car 110, i.e., a right protrusion portion 142b; accordingly, in the shaft, there is corresponding space for accommodating the left protrusion portion 142a and the right protrusion portion 142b of the propulsion device 140, thereby allowing the propulsion device 140 to move vertically in the up-down direction.

Alternatively, the host upper diverter pulleys 120a and 120b can be fixed to building members 900a and 900b respectively. The building members 900a and 900b are arranged to correspond to the left protrusion portion 142a and the right protrusion portion 142b of the propulsion device 140 in the up-down direction respectively. In this way, the host upper diverter pulley 120a is arranged to correspond to the left protrusion portion 142a of the propulsion device 140 in the up-down direction, and the host upper diverter pulley 120b is arranged to correspond to the right protrusion portion 142b of the propulsion device 140 in the up-down direction. Meanwhile, the host lower diverter pulley 150a is arranged to correspond to the left protrusion portion 142a of the propulsion device 140 in the up-down direction, and the host lower diverter pulley 150b is arranged to correspond to the right protrusion portion 142b of the propulsion device 140 in the up-down direction. In this way, the parts of the rope(s) 130 arranged in the up-down direction are correspondingly placed in the space allowing the left protrusion portion 142a and the right protrusion portion 142b to move in the up-down direction, and the parts of the rope(s) 130 arranged in the up-down direction do not interfere with the moving elevator car 110.

With continued reference to FIG. 4, the first end 131 of the rope 130a is fixed to the left protrusion portion 142a of the propulsion device 140, i.e., it is indirectly fixed to the elevator car 110 (since the propulsion device 140 is fixed to the elevator car 110). The rope 130a extends upward and wraps partially around the host upper diverter pulley 120a, extends downward and wraps partially around the low portion of the drive pulley 141a, extends continually and wraps partially around the top portion of the drive pulley 141b, extend downwards and wraps partially around the host lower diverter pulley 150b, and finally extends upward to the second end 132 of the rope 130a. The second end 132 of the rope 130a is fixed to the right protrusion portion 142b of the propulsion device 140, i.e., it is indirectly fixed to the elevator car 110 (since the propulsion device 140 is fixed to the elevator car 110).

The rope 130b and the rope 130a are arranged symmetrically in the left-right direction. To be specific, the first end 131 of the rope 130b is fixed to the right protrusion portion 142b of the propulsion device 140, i.e., it is indirectly fixed to the elevator car 110 (since the propulsion device 140 is fixed to the elevator car 110). The rope 130b extends upward and wraps partially around the host upper diverter pulley 120b, extends downward and wraps partially around the low portion of the drive pulley 141b, extends continually and wraps partially around the top portion of the drive pulley 141a, extend downwards and wraps partially around the host lower diverter pulley 150a, and finally extends upward to the second end 132 of the rope 130b. The second end 132 of the rope 130b is fixed to the left protrusion portion 142a of the propulsion device 140, i.e., it is indirectly fixed to the elevator car 110 (since the propulsion device 140 is fixed to the elevator car 110).

Driving the elevator car 110 of the elevator system 30 to move vertically upward in the shaft is taken as an example. Driven by the drive motors 143a and 143b, the drive pulley 141a rotates anticlockwise as shown in FIG. 4, and the drive pulley 141b rotates clockwise as shown in FIG. 4. The ropes 130a and 130b are pulled in the directions of the arrows shown in FIG. 4. Suppose the first ends 131 of the ropes 130a and 130b pull the elevator car 110 and the propulsion device 140 upward for a distance D, then the second ends 132 of the ropes 130a and 130b also move synchronously upward for a distance D in fact. Thus, in fact, the ropes 130a and 130b move for a distance 2D, i.e., the drive pulleys 141a and 141b rotate circumferentially for a distance 2D. In this way, the ratio of the linear rotation speed of the drive motors to the upward movement speed of the elevator car 110 is about 2:1.

On the basis of a substantially identical transmission principle, when the elevator car 110 is driven to move down in the shaft, the ratio of the linear rotation speed of the drive motors to the downward movement speed of the elevator car 110 is about 2:1.

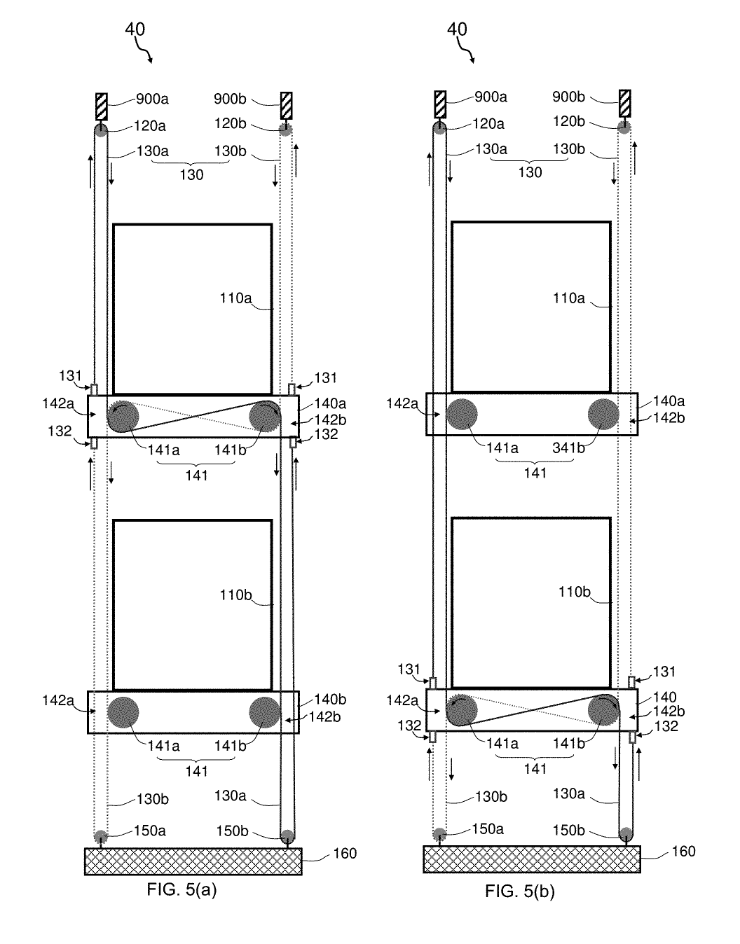

FIG. 5 is a schematic diagram of an elevator system according to a fourth embodiment of the present invention, wherein an elevator system 40 of the embodiment is formed on the basis of the elevator system 30 of the embodiment as shown in FIG. 4. The elevator system 40 comprises two elevator cars 110 arranged in a single shaft. Each elevator car 110 is provided with a propulsion device 140 comprising a paired drive pulley 141. The specific arrangement of a propulsion device 140a or 140b is identical with that of the propulsion device 140 in the elevator system 30 of the embodiment as shown in FIG. 4. Each elevator car 110 is provided with a rope(s) 130 for hoisting the elevator car 110. Different ropes 130 for hoisting different elevator cars 110 do not interfere with each other. FIG. 5(a) shows a rope(s) 130 arranged to correspond to an elevator car 110a. FIG. 5(b) shows a rope(s) 130 arranged to correspond to an elevator car 110b. It should be understood that the rope(s) 130 for hoisting the elevator car 110a is arranged to be separated in the front-back direction from the rope(s) 130 for hoisting the elevator car 110b. The two ends (131 and 132) of the rope(s) 130 for hoisting the elevator car 110a are fixed to the propulsion device 140a and can pass through the propulsion device 140b without interference with the propulsion device 140b. Likewise, the two ends (131 and 132) of the rope(s) 130 for hoisting the elevator car 110b are fixed to the propulsion device 140b and can pass through the propulsion device 140a without interference with the propulsion device 140a.

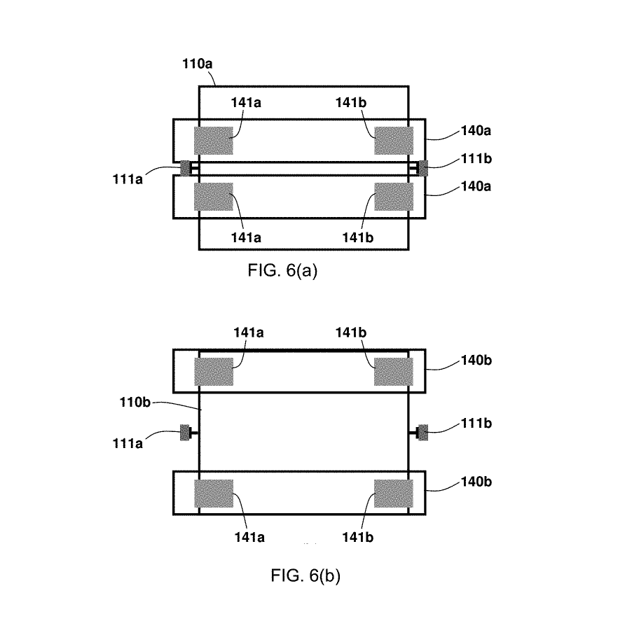

FIG. 6 is a bottom view of an elevator system according to a fourth embodiment of the present invention, and shows how to arrange the paired drive pulleys 141 and the propulsion devices 140 for different elevator cars to be staggered with each other. FIG. 6(a) is a bottom view of the elevator car 110a, and is a schematic diagram of arrangement of the paired drive pulley 141 and the propulsion device 140 on the elevator car 110a. FIG. 6(b) is a bottom view of the elevator car 110b, and is a schematic diagram of arrangement of the paired drive pulley 141 and the propulsion device 140 on the elevator car 110b.

As shown in FIG. 6, in the embodiment, the elevator cars 110a and 110b can be driven to move in the up-down direction along rails 111a and 111b arranged in the shaft respectively. The rails 111a and 111b are arranged symmetrically in the left-right direction, and are arranged both in the left-right direction and on substantially middle positions of the elevator cars 110 in the front-back direction respectively. Each elevator car 110 is provided with two paired drive pulleys 141 arranged basically in parallel with each other in the left-right direction. A drive pulley 141a and a drive pulley 141b of each paired drive pulley 141 are arranged in a straight line in the left-right direction. The paired drive pulleys 141 for the elevator car 110a and the paired drive pulleys 141 for the elevator car 110b are arranged in parallel with each other in the left-right direction and are staggered with each other in the front-back direction perpendicular to the left-right direction. For example, in the front-back direction, the two paired drive pulleys 141 and the propulsion device 140a for the elevator car 110a are arranged symmetrically, and the two paired drive pulleys 141 and the propulsion device 140b for the elevator car 110b are arranged symmetrically.

In the elevator system 40 of the above embodiment, the elevator car 110a and the elevator car 110b can share one tensioner 160. Each of the elevator car 110a and the elevator car 110b is provided with a host upper diverter pulley 120a, a host upper diverter pulley 120b, a host lower diverter pulley 150a, and a host lower diverter pulley 150b. FIG. 5(a) shows a host upper diverter pulley 120a, a host upper diverter pulley 120b, a host lower diverter pulley 150a, a host lower diverter pulley 150b, and a rope(s) 130 wrapping around them as arranged for the elevator car 110a, and FIG. 5(b) shows a host upper diverter pulley 120a, a host upper diverter pulley 120b, a host lower diverter pulley 150a, a host lower diverter pulley 150b, and a rope(s) 130 wrapping around them as arranged for the elevator car 110b.

It is noted that that in the elevator system 40, when driven by its propulsion device 140, the elevator car 110a can be controllably move in the up-down direction in the shaft above the elevator car 110b; when driven by its propulsion device 140, the elevator car 110b can be controllably move in the up-down direction in the shaft below the elevator car 110a. The rope for the elevator car neither interferes with the other rope for the other elevator car, nor interferes with the other elevator car and/or the propulsion device thereon. Therefore, the carrying efficiency of the elevator system 40 can be remarkably improved.

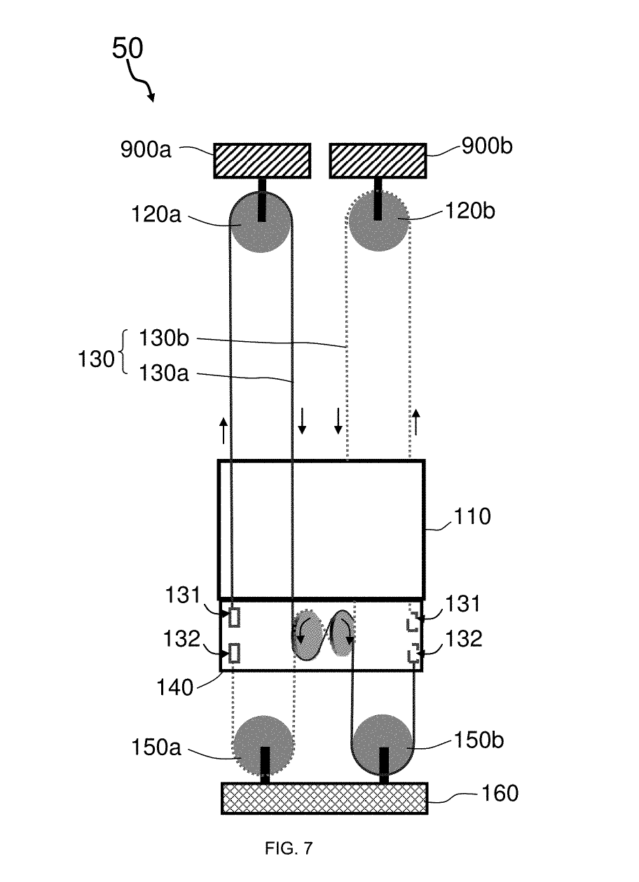

FIG. 7 is a schematic diagram of an elevator system according to a fifth embodiment of the present invention. An elevator system 50 also comprises components similar to the elevator car 110 and the tensioner(s) 160 in the elevator system 10, and further comprises one or more components as follows: the propulsion device 140; the paired drive pulley 141 in the propulsion device 140, which comprises the drive pulley 141a and the drive pulley 141b; host upper diverter pulleys 120a and 120b; host lower diverter pulleys 150a and 150b; and ropes 130a and 130b.

The arrangement of the above components is substantially identical with that of the corresponding components in the elevator system 10. Therefore, the specific depiction of the identical arrangement is omitted, and the main differences between the components in the elevator system 50 and the components in the elevator system 10 are elaborated below.

FIG. 7 is a left view of the elevator system 50. A host upper diverter pulley 120a, a host upper diverter pulley 120b, a host lower diverter pulley 150a, and a host lower diverter pulley 150b are substantially arranged in the front-back direction. In this way, two rope sections wrapping around each host upper diverter pulley 120 or host lower diverter pulley 150 are arranged in the front-back direction to save the space of the shaft. The drive pulley 141a and the drive pulley 141b of the paired drive pulley 141 are not arranged in the left-right direction, but are arranged to form a certain included angle with the left-right direction, e.g., the included angle ranges from 30 degrees to 50 degrees. Accordingly, the host upper diverter pulley 120a and the host lower diverter pulley 150b are located on the left and right of the elevator car 110 respectively, and are arranged to be staggered with each other in the front-back direction. The host lower diverter pulley 150a and the host upper diverter pulley 120b are located on the left and right of the elevator car 110 respectively, and are arranged to be staggered with each other in the front-back direction.

The rope(s) 130 in the elevator system 50 is arranged in the following manner.

As shown in FIG. 7, the first end(s) 131 of one or more ropes 130a is fixed to the left protrusion portion 142a of the propulsion device 140, i.e., it is indirectly fixed to the elevator car 110 (since the propulsion device 140 is fixed to the elevator car 110). The rope(s) 130a extends upward and wraps partially around the host upper diverter pulley 120a, extends downward and wraps partially around the low portion of the drive pulley 141a, extends continually and wraps partially around the top portion of the drive pulley 141b, extend downwards and wraps partially around the host lower diverter pulley 150b, and finally extends upward to the second end(s) 132 of the rope(s) 130a. The second end(s) 132 of the rope(s) 130a is fixed to the right protrusion portion 142b of the propulsion device 140, i.e., it is indirectly fixed to the elevator car 110 (since the propulsion device 140 is fixed to the elevator car 110).

As shown in FIG. 7, the first end(s) 131 of one or more ropes 130b is fixed to the right protrusion portion 142b of the propulsion device 140, i.e., it is indirectly fixed to the elevator car 110 (since the propulsion device 140 is fixed to the elevator car 110). The rope(s) 130b extends upward and wraps partially around the host upper diverter pulley 120b, extends downward and wraps partially around the low portion of the drive pulley 141b, extends continually and wraps partially around the top portion of the drive pulley 141a, extend downwards and wraps partially around the host lower diverter pulley 150a, and finally extends upward to the second end(s) 132 of the rope(s) 130b. The second end(s) 132 of the rope(s) 130b is fixed to the left protrusion portion 142a of the propulsion device 140, i.e., it is indirectly fixed to the elevator car 110 (since the propulsion device 140 is fixed to the elevator car 110).

Likewise, in the elevator system 50, the ratio of the linear rotation speed of the drive motors to the movement speed of the elevator car 110 is about 2:1.

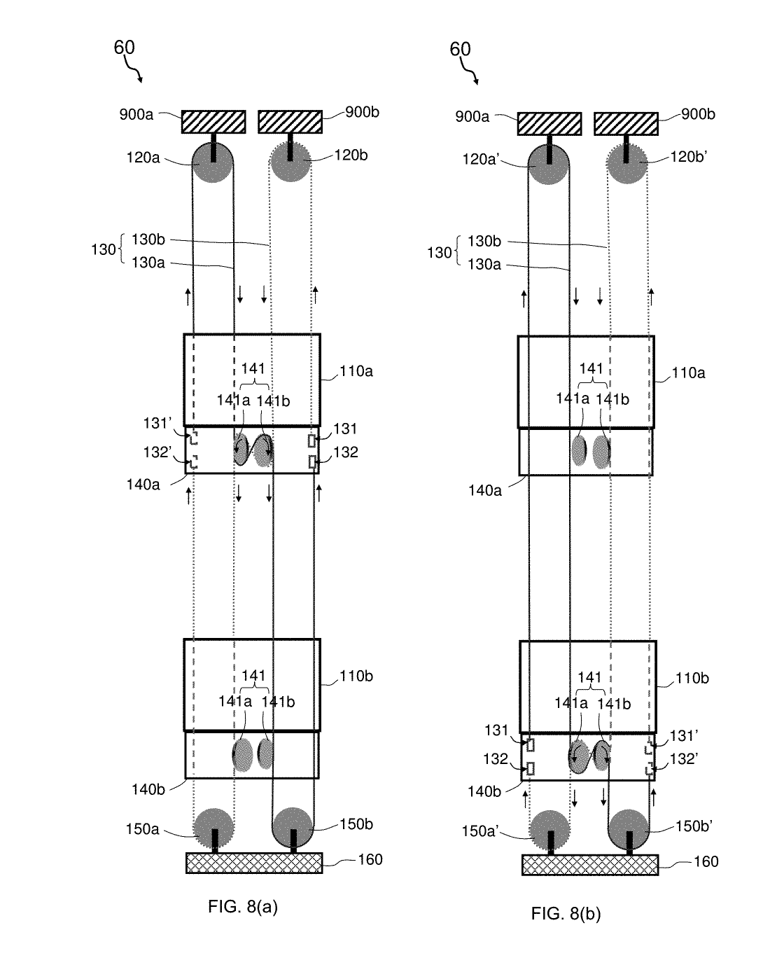

FIG. 8 is a schematic diagram of an elevator system according to a sixth embodiment of the present invention. FIG. 8(a) shows a rope(s) 130 arranged for an elevator car 110a. FIG. 8(b) shows a rope(s) 130 arranged for an elevator car 110b. It is noted that that FIG. 8(a) and FIG. 8(b) are side views of an elevator system 60, such as a left view. The elevator system 60 in the embodiment of the present invention is explained below with reference to FIGS. 8-10.

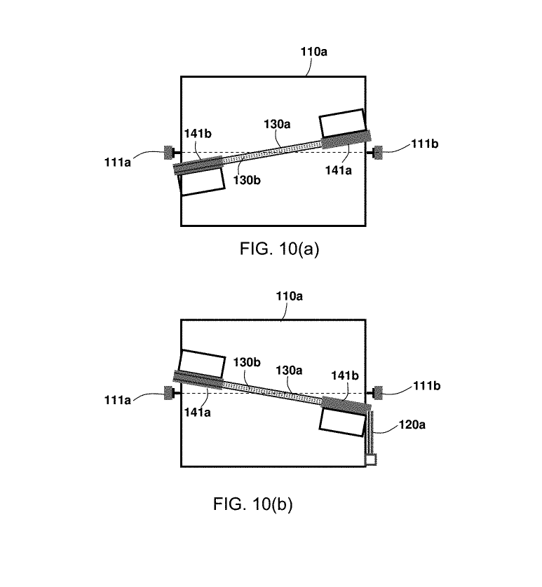

As shown in FIG. 8, the elevator system 60 of the embodiment is formed on the basis of the elevator system 50 in the embodiment as shown in FIG. 7. The elevator system 60 comprises two elevator cars 110a and 110b arranged in a single shaft. Each elevator car 110 is provided with a propulsion device 140 comprising a paired drive pulley 141. Paired drive pulleys (including a drive pulley 141a and a drive pulley 141b) in propulsion devices 140a and 140b are arranged in the manner as shown in FIG. 10, i.e., a paired drive pulley for the elevator car 110a and a paired drive pulley for the elevator car 110b, when vertically mapped on a bottom plane (i.e., a plane determined by the front-back direction and the left-right direction) of the shaft, are interlaced with each other. For example, an included angle +α is formed between the drive pulleys 141a, 141b and the rails 111a and 111b arranged in the left-right direction in FIG. 10(a); an included angle −α is formed between the drive pulleys 141a, 141b and the rails 111a, 111b arranged in the left-right direction in FIG. 10(b); in this way, when vertically mapped on the bottom plane of the shaft, they are interlaced with each other, and form an included angle 2a.

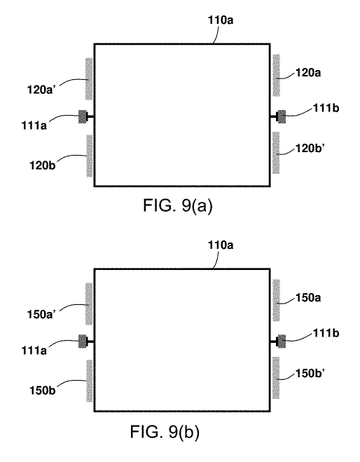

With continued reference to FIGS. 8 and 9, the elevator car 110a and the elevator car 110b can share one tensioner 160. Each of the elevator car 110a and the elevator car 110b is provided with host upper diverter pulleys and host lower diverter pulleys. In other words, the elevator car 110a is provided with a host upper diverter pulley 120a, a host upper diverter pulley 120b, a host lower diverter pulley 150a, and a host lower diverter pulley 150b, and the elevator car 110b is provided with a host upper diverter pulley 120a′, a host upper diverter pulley 120b′, a host lower diverter pulley 150a′, and a host lower diverter pulley 150b′. As shown in FIG. 9(a), the host upper diverter pulley 120a and the host upper diverter pulley 120b are interlaced with each other with respect to the host upper diverter pulley 120a′ and the host upper diverter pulley 120b′. As shown in FIG. 9(b), the host lower diverter pulley 150a and the host lower diverter pulley 150b are interlaced with each other with respect to the host lower diverter pulley 150a′ and the host lower diverter pulley 150b′.

With continued reference to FIG. 8, the two ends (131 and 132) of the rope(s) 130 for hoisting the elevator car 110a are fixed to the propulsion device 140a and can pass through the propulsion device 140 without interference with the propulsion device 140b. Likewise, the two ends (131 and 132) of the rope(s) 130 for hoisting the elevator car 110b are fixed to the propulsion device 140b and can pass through the propulsion device 140a without interference with the propulsion device 140. The arrangement manner of the rope(s) 130 for each elevator car 110 is similar to that of the rope in the embodiment as shown in FIG. 7. The dotted rope sections in FIG. 8 refer to those that are invisible or blocked by the elevator car or the propulsion device.

In the elevator system 60 of the above embodiment, when driven by its propulsion device 140, the elevator car 110a can be controllably move in the up-down direction in the shaft above the elevator car 110b; when driven by its propulsion device 140, the elevator car 110b can be controllably move in the up-down direction in the shaft below the elevator car 110a. The rope for the elevator car neither interferes with the other rope for the other elevator car, nor interferes with the other elevator car and/or the propulsion device thereon. Therefore, the carrying efficiency of the elevator system 60 can be remarkably improved.

In the elevator system 60 of the above embodiment, a round rope may be used as the rope 130.

It should be understood that in the elevator system 40 or 60, more elevator cars 110 can be arranged in a single shaft in the manner as shown in FIG. 5 or 8.

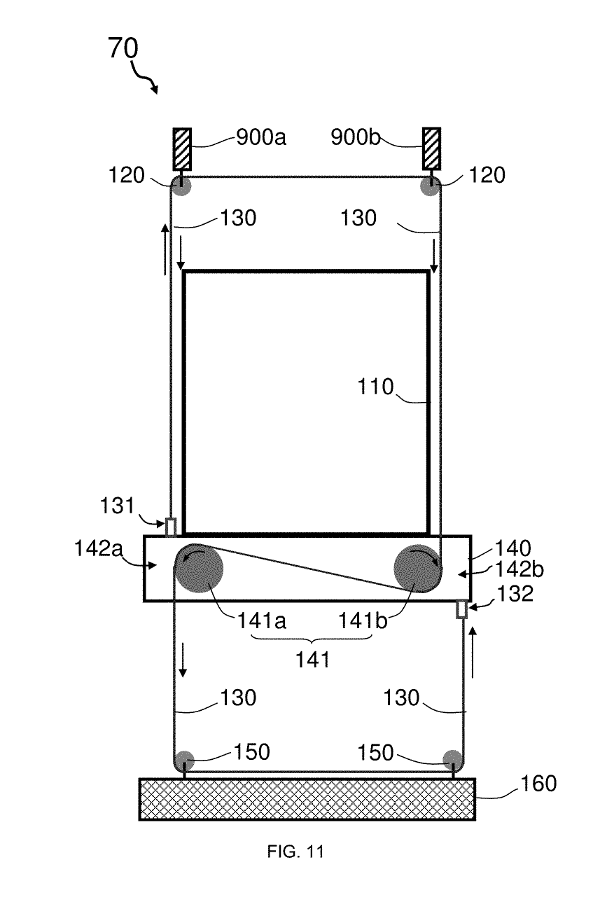

FIG. 11 is a schematic diagram of an elevator system according to a seventh embodiment of the present invention. The elevator system 70 provides single group rope 130, while not two groups of ropes 130a and 130b, for climbing the elevator car 110. Two host upper diverter pulleys 120 and two host lower diverter pulleys 150 are arranged for the single group rope 130 correspondingly. In one embodiment, the first end 131 and the second end 132 of the single group rope 130 are fixed with respect to opposite both sides (for instance left and right sides) of the elevator car 110 respectively. For instance, the first end 131 of the rope 130 is fixed to the left side of the propulsion device 140, and the second end 132 of the rope 130 is fixed to the right side of the propulsion device 140. In such, the single group rope 130 could exert climbing force on the elevator car in balance of left and right.

In particular, as shown in FIG. 11, the first end 131 of the rope 130 is fixed to the left protrusion portion 142a of the propulsion device 140; the rope 130 extends upward and wraps partially around the two host upper diverter pulleys 120, extends downward and wraps partially around the low portion of the drive pulley 141a, extends continually and wraps partially around the top portion of the drive pulley 141b, extend downwards and wraps partially around the two host lower diverter pulleys 150, and finally extends upward to the second end 132 of the rope 130. The second end 132 of the rope 130 is fixed to the right protrusion portion 142b of the propulsion device 140, i.e., it is indirectly fixed to the elevator car 110 (since the propulsion device 140 is fixed to the elevator car 110).

With reference to FIG. 11, driving the elevator car 110 to move vertically upward in the shaft is taken as an example. Driven by the drive motors 143a and 143b, the drive pulley 141a rotates anticlockwise as shown in the figures, and the drive pulley 141b rotates clockwise as shown in the FIG. 11. The ropes 130 are pulled in the directions of the arrows shown in the FIG. 11. Suppose the first end 131 of the rope 130 pull the elevator car 110 upward for a distance D, then the second end 132 of the rope 130 also move synchronously upward for a distance D. Thus, in fact, the rope 130 move for a distance 2D, i.e., the drive pulleys 141a and 141b rotate circumferentially for a distance 2D. In this way, the ratio of the linear rotation speed of the drive motors 143a and 143b to the upward movement speed of the elevator car 110 is about 2:1.

In the elevator system 70, when the elevator car 110 moves vertically in the shaft, the two host upper diverter pulleys 120 rotate in an identical direction, and the two host lower diverter pulleys 150 rotate in an identical direction. It is understood that numbers of the host upper diverter pulley 120 or the host lower diverter pulley 150 are not limited as two; for example, three or more host upper diverter pulleys 120 or host lower diverter pulleys 150 can be arranged to in left-right direction.

In the elevator systems shown in FIG. 1 to FIG. 11, the linear speed of the drive pulley 141a and 141b to a movement speed of the elevator car 110 is about 2:1 in the climbing process. Wherein the first end 131 and the second end 132 of each rope 130 in the elevator systems 10-70 have a fixing manner in which the first end 131 and the second end 132 are fixed with respect to the elevator car 110 and move along the up-down direction in sync with the elevator car 110; a part of ropes between the first end 131 and the host upper diverter pulleys 120 have an arrangement manner extending upward directly, a part of ropes between the second end 132 and the host lower diverter pulleys 150 have an arrangement manner extending downward directly. In such, a ratio of a linear speed of the host upper diverter pulleys 120 and host lower diverter pulleys 150 to the movement speed of the elevator car 110 is about 1:1 in the climbing process.

The case in which the linear speed of the drive pulley 141a and 141b to a movement speed of the elevator car 110 is larger than 2:1 is further exemplary illustrated as below.

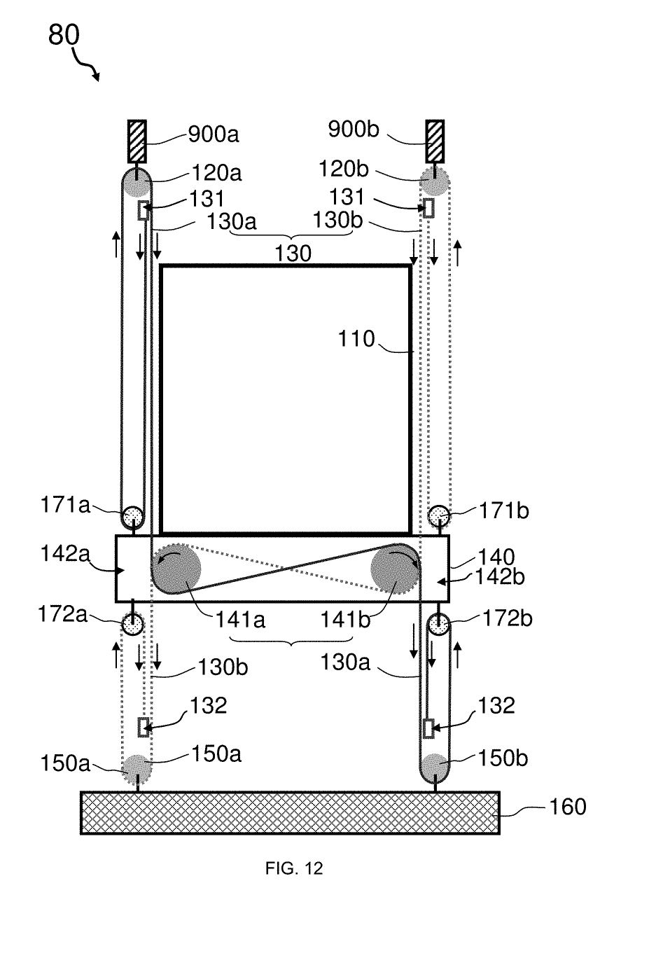

FIG. 12 is a schematic diagram of an elevator system according to an eighth embodiment of the present invention. The elevator system 80 also comprises components similar to the elevator car 110 and the tensioner(s) 160 in the elevator system 30, and further comprises one or more components as follows: the propulsion device 140 with the first protrusion portion 142a and the second protrusion portion 142b; the paired drive pulley 141 in the propulsion device 140, which comprises the drive pulley 141a and the drive pulley 141b; host upper diverter pulleys 120a and 120b; host lower diverter pulleys 150a and 150b; and ropes 130a and 130b.

The arrangement of the above components is substantially identical with that of the corresponding components in the elevator system 10. Therefore, the specific depiction of the identical arrangement is omitted herein, and the main differences between the elevator system 80 and the elevator system 30 are elaborated below.

The elevator system 80 further provides first middle diverter pulleys 171a and 171b and second middle diverter pulleys 172a and 172b that are fixed with respect to the elevator car 110 (for instance fixed on the first protrusion portion 142a and the second protrusion portion 142b of the propulsion device 140) and move along the up-down direction in sync with the elevator car 110. Wherein, the first middle diverter pulley 171a and the second middle diverter pulley 171b are provided to the ropes 130a correspondingly and are wrapped partially by the rope 130a; and the first middle diverter pulley 171b and the second middle diverter pulley 171a are provided to the ropes 130b correspondingly and are wrapped partially by the rope 130b.

Moreover, in the elevator system 80, the first ends 131 of ropes 130a and 130b are fixed above the first middle diverter pulleys 171a and 171b respectively; the second ends 131 of ropes 130a and 130b are fixed below the second middle diverter pulleys 172a and 172b respectively; and the first ends 131 and the second ends 132 are immobile in the up-down direction in the climbing process.

In this way, as shown in FIG. 12, as for rope 130a, it firstly extends downward from the first end 131 and warps partially around the first middle diverter pulley 171a, extends upward and wraps partially around the host upper diverter pulley 120a, extends downward and wraps partially around the low portion of the drive pulley 141a, extends continually and wraps partially around the top portion of the drive pulley 141b, extends downward and wraps partially around the host lower diverter pulleys 150b, extends upward and wraps partially around the second middle diverter pulley 172b, and finally extends downward to the second end 132. As for rope 130b, it firstly extends downward from the first end 131 and warps partially around the first middle diverter pulley 171b, extends upward and wraps partially around the host upper diverter pulley 120b, extends downward and wraps partially around the low portion of the drive pulley 141b, extends continually and wraps partially around the top portion of the drive pulley 141a, extends downward and wraps partially around the host lower diverter pulleys 150a, extends upward and wraps partially around the second middle diverter pulley 172a, and finally extends downward to the second end 132.

Driving the elevator car 110 of the elevator system 80 to move vertically upward in the shaft is taken as an example. Driven by the drive motors 143a and 143b, the drive pulley 141a rotates anticlockwise as shown in FIG. 12, and the drive pulley 141b rotates clockwise as shown in FIG. 12. The ropes 130a and 130b are pulled in the directions of the arrows shown in FIG. 12. Suppose the elevator car 110 and the propulsion device 140 move upward together for a distance D, then the first middle diverter pulleys 171a and 171b and the second middle diverter pulleys 172a and 172b move upward together for a distance D either; thus, a movement distance of a part of ropes is wrapped partially around the host upper diverter pulley 120 and the host lower diverter pulley 150 is 2D, and a movement distance of a part of ropes is wrapped partially around the drive pulleys 141a and 141b is 3D, that is, the host upper diverter pulley 120 and the host lower diverter pulley 150 rotate circumferentially for a distance 2D, and the drive pulleys 141a and 141b rotate circumferentially for a distance 3D. In this way, the ratio of the linear rotation speed of the drive pulleys 141a and 141b to the upward movement speed of the elevator car 110 is about 3:1, accordingly, the ratio of the linear rotation speed of the drive motors to the upward movement speed of the elevator car 110 is about 3:1, which further lowers the torque requirement for the drive motor 143a and 143b.

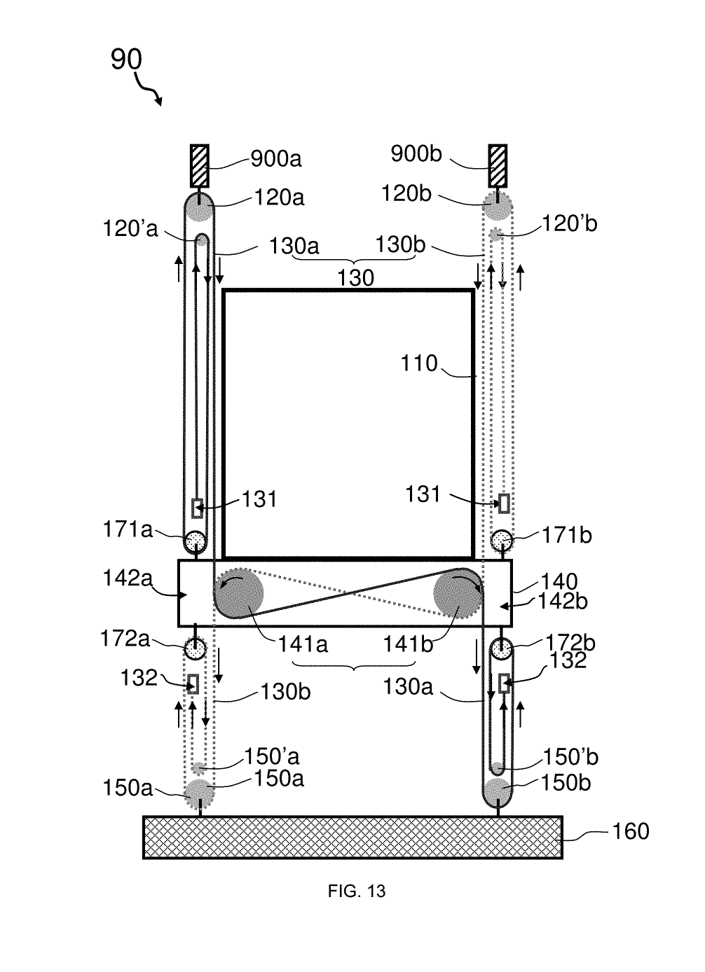

FIG. 13 is a schematic diagram of an elevator system according to a ninth embodiment of the present invention. The elevator system 90 also comprises components similar to the elevator car 110 and the tensioner(s) 160 in the elevator system 30, and further comprises one or more components as follows: the propulsion device 140 with the first protrusion portion 142a and the second protrusion portion 142b; the paired drive pulley 141 in the propulsion device 140, which comprises the drive pulley 141a and the drive pulley 141b; host upper diverter pulleys 120a and 120b; host lower diverter pulleys 150a and 150b; and ropes 130a and 130b.

The arrangement of the above components is substantially identical with that of the corresponding components in the elevator system 10. Therefore, the specific depiction of the identical arrangement is omitted herein, and the main differences between the elevator system 90 and the elevator system 30 are elaborated below.

The elevator system 90 further provides first middle diverter pulleys 171a and 171b and second middle diverter pulleys 172a and 172b that are fixed with respect to the elevator car 110 (for instance fixed on the first protrusion portion 142a and the second protrusion portion 142b of the propulsion device 140) and move along the up-down direction in sync with the elevator car 110; the elevator system 90 further provides slave upper diverter pulleys 120′a and 120′b which are fixedly arranged above the elevator car 110 and slave lower diverter pulleys 150′ a and 150′b which are fixed to the tensioner(s) 160. Wherein, the slave upper diverter pulleys 120′a, the first middle diverter pulley 171a, the second middle diverter pulley 171b and the slave lower diverter pulley 150′b are provided to the ropes 130a correspondingly and are wrapped partially by the rope 130a; and the slave upper diverter pulleys 120′b, the first middle diverter pulley 171b, the second middle diverter pulley 171a and the slave lower diverter pulley 150′a are provided to the ropes 130b correspondingly and are wrapped partially by the rope 130b.

Moreover, in the elevator system 90, the first ends 131 and the second ends 132 of ropes 130a and 130b are fixed with respect to the elevator car 110 and move along the up-down direction in sync with the elevator car 110 in the climbing process.

In this way, as shown in FIG. 13, as for rope 130a, it firstly extends upward and wraps partially around the slave upper diverter pulley 120′a, extends downward from the first end 131 and warps partially around the first middle diverter pulley 171a, extends upward and wraps partially around the host upper diverter pulley 120a, extends downward and wraps partially around the low portion of the drive pulley 141a, extends continually and wraps partially around the top portion of the drive pulley 141b, extends downward and wraps partially around the host lower diverter pulleys 150b, extends upward and wraps partially around the second middle diverter pulley 172b, extends upward and wraps partially around the slave lower diverter pulley 150′b, and finally extends downward to the second end 132. As for rope 130b, it firstly extends upward and wraps partially around the slave upper diverter pulley 120′b, extends downward from the first end 131 and warps partially around the first middle diverter pulley 171b, extends upward and wraps partially around the host upper diverter pulley 120b, extends downward and wraps partially around the low portion of the drive pulley 141b, extends continually and wraps partially around the top portion of the drive pulley 141a, extends downward and wraps partially around the host lower diverter pulleys 150a, extends upward and wraps partially around the second middle diverter pulley 172a, extends upward and wraps partially around the slave lower diverter pulley 150′a, and finally extends downward to the second end 132.

Driving the elevator car 110 of the elevator system 90 to move vertically upward in the shaft is taken as an example. Driven by the drive motors 143a and 143b, the drive pulley 141a rotates anticlockwise as shown in FIG. 13, and the drive pulley 141b rotates clockwise as shown in FIG. 13. The ropes 130a and 130b are pulled in the directions of the arrows shown in FIG. 13. Suppose the elevator car 110 and the propulsion device 140 move upward together for a distance D, then the first end 131 and the second end 132 of each rope 130 and the first middle diverter pulleys 171a and 171b and the second middle diverter pulleys 172a and 172b move upward together for a distance D either; thus, a movement distance of a part of ropes is wrapped partially around the host upper diverter pulley 120 and the host lower diverter pulley 150 is 3D, and a movement distance of a part of ropes is wrapped partially around the drive pulleys 141a and 141b is 4D, that is, the host upper diverter pulley 120 and the host lower diverter pulley 150 rotate circumferentially for a distance 3D, and the drive pulleys 141a and 141b rotate circumferentially for a distance 4D. In this way, the ratio of the linear rotation speed of the drive pulleys 141a and 141b to the upward movement speed of the elevator car 110 is about 4:1, accordingly, the ratio of the linear rotation speed of the drive motors to the upward movement speed of the elevator car 110 is about 3:1, which further lowers the torque requirement for the drive motor 143a and 143b.

It should be understood that the elevator system 80 or 90 in above embodiments can realize that a plurality of elevator cars 110 are arranged in a single shaft basing on the arrangement similar to the elevator system 40 as shown in FIG. 5.

It is noted that that, in this text, a rope 130 or 130a or 130b is not confined as “one rope”, instead, it could be a rope cluster constituted of a plurality of ropes; ropes 130 can indicate either a plurality of ropes or a plurality of rope groups.

The above instances mainly explain various elevator systems of the present invention. Although only some of the embodiments of the elevator systems are described in the present invention, those skilled in the art should understand that the present invention can be implemented in many other forms without departing from the spirit and scope thereof. Therefore, the disclosed examples and embodiments should be considered as illustrative rather than limiting. The invention can cover many variations and replacements without departing from the spirit and scope of the invention defined by the appended claims.

1. A rope climbing elevator system (10,20,30,40,50,60,30,40,50,60,70,80,90), comprising:
an elevator car (110), which can move along an up-down direction;
one or more host upper diverter pulleys (120), which are fixedly arranged above the elevator car (110);
one or more tensioners (160), which are located below the elevator car (110);
one or more host lower diverter pulleys (150), which are fixed to the tensioners (160);
one or more ropes (130); and
a counter-rotating paired drive pulley (141), which is fixed to the elevator car (110) and comprises a first drive pulley (141a/141b) and a second drive pulley (141b/141a) that are adapted to engage with the ropes (130);
wherein a ratio of a linear speed of the first drive pulley (141a/141b) and the second drive pulley (141b/141a) to a movement speed of the elevator car (110) is about X:1 in the climbing process, X is larger than or equal to 2.

2. The elevator system (10,20,30,40,50,60,30,40,50,60,70,80,90) of claim 1, wherein each of the one or more ropes (130) wraps partially around the one or more host upper diverter pulleys (120), extends downward and wrap partially around a low portion of the first drive pulley (141a/141b), extends continually and wrap partially around a top portion of the second drive pulley (141b/141a), and extends downward and wrap partially around the one or more host lower diverter pulleys (150);
fixing manners of a first end (131) and a second end (132) of each of the one or more ropes (130) with respect to the elevator car (110) and/or arrangement of a part of ropes (130) between the first end (131) and the host upper diverter pulleys (120) and a part of ropes (130) between the second end (132) and the host lower diverter pulleys (150) are arranged in certain manner such that a ratio of a linear speed of the host upper diverter pulleys (120) and host lower diverter pulleys (150) to the movement speed of the elevator car (110) is about (X−1):1 in the climbing process.

3. The elevator system (10,20,30,40,50,60,30,40,50,60,70,80,90) of claim 1, wherein a first end (131) and a second end (132) of each of the one or more ropes (130) are fixed with respect to the elevator car (110) and each of the one or more ropes (130) is arranged to:
firstly extend upward from the first end (131) and wrap partially around the one or more host upper diverter pulleys (120), extend downward and wrap partially around a low portion of the first drive pulley (141a/141b), extend continually and wrap partially around a top portion of the second drive pulley (141b/141a), extend downward and wrap partially around the one or more host lower diverter pulleys (150), and finally extend upward to the second end (132).

4. The elevator system (10,20,30,40,50,60,30,40,50,60,70,80,90) of claim 1, wherein the elevator system further comprises:
one or more first middle diverter pulleys (171a, 171b) and one or more second middle diverter pulleys (172a, 172b), which are fixed with respect to the elevator car (110) and move along the up-down direction in sync with the elevator car (110) in the climbing process;
wherein the first middle diverter pulleys (171a, 171b) are arranged with opposite to the host upper diverter pulleys (120), the second middle diverter pulleys (172a, 172b) are arranged with opposite to the host lower diverter pulleys (150).

5. The elevator system (10,20,30,40,50,60,30,40,50,60,70,80,90) of claim 4, wherein X is and odd number lager than or equal to 3; a first end (131) and a second end (132) of each of the one or more ropes (130) are fixed above the first middle diverter pulleys (171a, 171b) and below the second middle diverter pulleys (172a, 172b) respectively, and are immobile in the up-down direction in the climbing process;
each of the one or more ropes (130) is arranged to:
firstly extend downward from the first end (131) and warp partially around the first middle diverter pulleys (171a, 171b), extend upward and wrap partially around the one or more host upper diverter pulleys (120), extend downward and wrap partially around a low portion of the first drive pulley (141a/141b), extend continually and wrap partially around a top portion of the second drive pulley (141b/141a), extend downward and wrap partially around the one or more host lower diverter pulleys (150), extend upward and wrap partially around the second middle diverter pulleys (172a, 172b), and finally extend downward to the second end (132).

6. The elevator system (10,20,30,40,50,60,30,40,50,60,70,80,90) of claim 4, wherein X is and even number lager than or equal to 4; the elevator system further comprises:
one or more slave upper diverter pulleys (120′), which are fixedly arranged above the elevator car (110); and
one or more slave lower diverter pulleys (150′), which are fixed to the tensioners (160;
wherein a first end (131) and a second end (132) of each of the one or more ropes (130) are fixed with respect to the elevator car (110) and each of the one or more ropes (130) is arranged to:
firstly extend upward from the first end (131) and wrap partially around slave upper diverter pulleys (120′), extend downward and wrap partially around the first middle diverter pulleys (171a, 171b), extend upward and wrap partially around the one or more host upper diverter pulleys (120), extend downward and wrap partially around a low portion of the first drive pulley (141a/141b), extend continually and wrap partially around a top portion of the second drive pulley (141b/141a), extend downward and wrap partially around the one or more host lower diverter pulleys (150), extend upward and wrap partially around the second middle diverter pulleys (172a, 172b), extend downward and wrap partially around slave lower diverter pulleys (150′), and finally extend upward to the second end (132).

7. The elevator system (10,20,30,40,50,60,30,40,50,60,70,80,90) of claim 1, wherein the first end (131) and the second end (132) of each of the one or more ropes (130) are fixed with respect to opposite both sides of the elevator car (110) respectively.

8. The elevator system (10,20,30,40,50,60,30,40,50,60,70,80,90) of claim 1, wherein each of the one or more ropes (130) is a flat rope.

9. The elevator system (10,20,30,40,50,60,30,40,50,60,70,80,90) of claim 1, wherein the paired drive pulley (141) is fixed above top or below bottom of the elevator car (110).

10. The elevator system (10,20,30,40,50,60,30,40,50,60,70,80,90) of claim 1, wherein the host upper diverter pulleys (120) comprises a first host upper diverter pulley (120a) and a second host upper diverter pulleys (120b) that are arranged to correspond to a first side edge and a second side edge, opposite to each other, of the elevator car (110) respectively;
the host lower diverter pulleys (150) comprises a first host lower diverter pulley (150a) and a second host lower diverter pulley (150b) that are arranged to correspond to the first side edge and the second side edge, opposite to each other, of the elevator car (110) respectively;
the ropes (130) comprise a first rope (130a) and a second rope (130b).

11. The elevator system (10,20,30,40,50,60,30,40,50,60,70,80,90) of claim 10, wherein the first rope (130a) is arranged in such a manner that the first end (131) of the first rope (130a) is fixed to correspond to the first side edge of the elevator car (110), extends upward and wraps partially around the first host upper diverter pulley (120a), extends downward and wraps partially around the low portion of the first drive pulley (141a/141b), extends continually and wraps partially around the top portion of the second drive pulley (141b/141a), extends downward and wraps partially around the second host lower diverter pulley (150b), and finally extends upward to the second end (132) of the first rope (130a), the second end (132) of the first rope (130a) being fixed to correspond to the second side edge of the elevator car (110);
wherein the second rope (130b) is arranged in such a manner that the first end (131) of the second rope (130b) is fixed to correspond to the second side edge of the elevator car (110), extends upward and wraps partially around the second host upper diverter pulley (120b), extends downward and wraps partially around the low portion of the second drive pulley (141b/141a), extends continually and wraps partially around the top portion of the first drive pulley (141a/141b), extends downward and wraps partially around the first host lower diverter pulley (150a), and finally extends upward to the second end (132) of the second rope (130b), the second end (132) of the second rope (130b) being fixed to correspond to the first side edge of the elevator car (110).

12. The elevator system (10,20,30,40,50,60,30,40,50,60,70,80,90) of claim 10, wherein the first host upper diverter pulley (120a) and the first host lower diverter pulley (150a) are substantially arranged on a straight line in the up-down direction; the second host upper diverter pulley (120b) and the second host lower diverter pulley (150b) are substantially arranged on another straight line in the up-down direction.

13. The elevator system (10,20,30,40,50,60,30,40,50,60,70,80,90) of claim 10, wherein the first host upper diverter pulley (120a) and the second host upper diverter pulley (120b) are basically identical, and the first host upper diverter pulley (120a) and the second host upper diverter pulley (120b) are arranged substantially in bilateral symmetry.

14. The elevator system (10,20,30,40,50,60,30,40,50,60,70,80,90) of claim 10, wherein the first host lower diverter pulley (150a) and the second host lower diverter pulley (150b) are basically identical, and the first host lower diverter pulley (150a) and the second host lower diverter pulley (150b) are arranged substantially in bilateral symmetry.

15. The elevator system (10,20,30,40,50,60,30,40,50,60,70,80,90) of claim 10, wherein the rope (130a) and the rope (130b) are arranged substantially in bilateral symmetry.

16. The elevator system (10,20,30,40,50,60,30,40,50,60,70,80,90) of claim 10, wherein the first drive pulley (141a/141b) and the second drive pulley (141b/141a) are grooved sheaves that have a plurality of grooves for engaging with the ropes (130), and on the first drive pulley (141a/141b) and the second drive pulley (141b/141a) of each of the paired drive pulley (141), different grooves are allocated to engage with the first rope (130a) and the second rope (130b) correspondingly.

17. The elevator system (10,20,30,40,50,60,30,40,50,60,70,80,90) of claim 10, wherein spin axes of the first drive pulley (141a/141b) and the second drive pulley (141b/141a) are arranged in parallel, and the first drive pulley (141a/141b) and the second drive pulley (141b/141a) are have identical configurations.

18. The elevator system (10,20,30,40,50,60,30,40,50,60,70,80,90) of claim 1, wherein the tensioners (160) are arranged in such a manner that a downward force applied by the tensioners (160) to the host lower diverter pulleys (150) to tension the one or more ropes (130) can avoid relative slip between the first drive pulley (141a/141b) or the second drive pulley (141b/141a) and the one or more ropes (130) when the elevator car (110) is moving or static.

19. The elevator system (10,20,30,40,50,60,30,40,50,60,70,80,90) of claim 18, the tensioners (160) are further arranged in such a manner that the tension force of the one or more ropes (130), generated by the downward force exerted on the host lower diverter pulleys (150), does not exceed the largest allowable tensile stress of the one or more ropes (130).

20. The elevator system (10,20,30,40,50,60,30,40,50,60,70,80,90) of claim 18, wherein when the elevator car (110) is static, the first drive pulley (141a/141b) and the second drive pulley (141b/141a) of the paired drive pulley (141) are braked.

21. The elevator system (10,20,30,40,50,60,30,40,50,60,70,80,90) of claim 18, wherein the tensioners (160) is basically static in the up-down direction when the elevator car (110) is moving or static.

22. The elevator system (10,20,30,40,50,60,30,40,50,60,70,80,90) of claim 1, wherein a distance between the first drive pulley (141a/141b) and the second drive pulley (141b/141a) and/or a radius of the first drive pulley (141a/141b) and the second drive pulley (141b/141a) are/is arranged to avoid interference between the ropes (130) and side faces of the elevator car (110).

23. The elevator system (10,20,30,40,50,60,30,40,50,60,70,80,90) of claim 2, wherein each of the one or more ropes (130) wraps partially around and engages with at least part of a lower arc surface of the first drive pulley (141a/141b), and simultaneously wraps partially around and engages with at least part of an upper arc surface of the second drive pulley (141b/141a), and then bends substantially vertically to extend downward to the host lower diverter pulley (150).

24. The elevator system (10,20,30,40,50,60,30,40,50,60,70,80,90) of claim 1, wherein the ropes (130) wraps round the host upper diverter pulley (120) or the host lower diverter pulley (150) by substantially covering a 180-degree arc surface of the host upper diverter pulleys (120) or the host lower diverter pulleys (150).

25. The elevator system (10,20,30,40,50,60,30,40,50,60,70,80,90) of claim 1, further comprising a propulsion device (140), which comprises the paired drive pulley (141) and one or more drive motors for driving the first drive pulley (141a/141b) and the second drive pulley (141b/141a) to rotate in opposite directions;
wherein the propulsion device (140) is integrally fixed above top or below bottom of the elevator car (110).

26. The elevator system (10,20,30,40,50,60,30,40,50,60,70,80,90) of claim 25, wherein the drive motors are configured to generate electricity to recover energy when the elevator car (110) moves down.

27. The elevator system (10,20,30,40,50,60,30,40,50,60,70,80,90) of claim 25, wherein the propulsion device (140) has a first protrusion portion (142a) and a second protrusion portion (142b) that are arranged to protrude toward a first side and a second side with respect to the elevator car (110) respectively;
the host upper diverter pulleys (120) comprises a first host upper diverter pulley (120a) that is arranged to correspond to the first protrusion portion (142a) of the propulsion device (140) in the up-down direction and a second host upper diverter pulley (120b) that is arranged to correspond to the second protrusion portion (142b) of the propulsion device (140) in the up-down direction;
the host lower diverter pulleys (150) comprises a first host lower diverter pulley (150a) that is arranged to correspond to the first protrusion portion (142a) of the propulsion device (140) in the up-down direction and a second host lower diverter pulley (150b) that is arranged to correspond to the second protrusion portion (142b) of the propulsion device (140) in the up-down direction;
the ropes (130) comprise a first rope (130a) and a second rope (130b).

28. The elevator system (10,20,30,40,50,60,30,40,50,60,70,80,90) of claim 27, wherein the first rope (130a) is arranged in such a manner that the first end (131) of the first rope (130a) is fixed to the first protrusion portion (142a) of the propulsion device (140), extends upward and wraps partially around the first host upper diverter pulley (120a), extends downward and wraps partially around the low portion of the first drive pulley (141a/141b), extends continually and wraps partially around the top portion of the second drive pulley (141b/141a), extends downward and wraps partially around the second host lower diverter pulley (150b), and finally extends upward to the second end (132) of the first rope (130a), the second end (132) of the first rope (130a) being fixed to the second protrusion portion (142b) of the propulsion device (140);
wherein the second rope (130b) is arranged in such a manner that the first end (131) of the second rope (130b) is fixed to the second protrusion portion (142b) of the propulsion device (140), extends upward and wraps partially around the second host upper diverter pulley (120b), extends downward and wraps partially around the low portion of the second drive pulley (141b/141a), extends continually and wraps partially around the top portion of the first drive pulley (141a/141b), extends downward and wraps partially around the first host lower diverter pulley (150a), and finally extends upward to the second end (132) of the second rope (130b), the second end (132) of the second rope (130b) being fixed to the first protrusion portion (142a) of the propulsion device (140).

29. The elevator system (10,20,30,40,50,60,30,40,50,60,70,80,90) of claim 1, comprising two or more elevator cars (110) arranged in a single shaft, wherein each of the elevator cars (110) is provided with the paired drive pulley (141) or the propulsion device (140) correspondingly, each of the elevator cars (110) is provided with the one or more ropes (130) for climbing correspondingly, and different ropes (130) for hoisting different elevator cars (110) do not interfere with each other.

30. The elevator system (10,20,30,40,50,60,30,40,50,60,70,80,90) of claim 29, wherein the paired drive pulley (141) for each of the elevator cars (110) is arranged to be staggered with the paired drive pulley (141) for another the elevator cars (110), such that the ropes (130) for each of the elevator cars (110) neither interferes with another ropes (130) for another of the elevator cars (110), nor interferes with another of the elevator cars (110) and/or a propulsion device (140) on another of the elevator cars (110).

31. The elevator system (10,20,30,40,50,60,30,40,50,60,70,80,90) of claim 30, wherein the paired drive pulley (141) for each of the elevator cars (110) and another paired drive pulley (141) for another of the elevator cars (110) are in parallel in a left-right direction and are staggered with each other in a front-back direction perpendicular to the left-right direction.

32. The elevator system (10,20,30,40,50,60,30,40,50,60,70,80,90) of claim 30, wherein the paired drive pulley (141) for each of the elevator cars (110) and the paired drive pulley (141) for another of the elevator cars (110), when vertically mapped on a bottom plane of the shaft, are interlaced with each other.

33. The elevator system (10,20,30,40,50,60,30,40,50,60,70,80,90) of claim 30, wherein each of the elevator cars (110) is provided with the first host upper diverter pulley (120a), the second host upper diverter pulley (120b), the first host lower diverter pulley (150a) and the second host lower diverter pulley (150b) that are arranged substantially in the front-back direction perpendicular to the left-right direction respectively.

34. The elevator system (10,20,30,40,50,60,30,40,50,60,70,80,90) of claim 1, wherein the host lower diverter pulleys (150) are arranged on a surface of the one or more tensioners (160), which surface faces the elevator car (110).

35. The elevator system (10,20,30,40,50,60,30,40,50,60,70,80,90) of claim 1, wherein a hoisting height of the elevator system (10,20,30,40,50,60,30,40,50,60,70,80,90) is equal to or greater than 100 meters, or equal to or greater than 200 meters, or equal to or greater than 300 meters.

36. A rope climbing elevator system (10,20,30,40,50,60,30,40,50,60,70,80,90), comprising:
a plurality of elevator cars (110), which are arranged in a single shaft and can move along an up-down direction; and
one or more tensioners (160), which are located below said plurality of elevator cars (110);
wherein each of said plurality of elevator cars (110) is provided with:
one or more ropes (130) for hoisting each of said plurality of elevator cars (110);
one or more host upper diverter pulleys (120), which are fixedly arranged above each of said plurality of elevator cars (110);
one or more host lower diverter pulleys (150), which are fixed to the tensioners (160); and
a counter-rotating paired drive pulley (141), which is fixed to each of said plurality of elevator cars (110) and comprises a first drive pulley (141a/141b) and a second drive pulley (141b/141a) that are adapted to engage with the ropes (130);
wherein a ratio of a linear speed of the first drive pulley (141a/141b) and the second drive pulley (141b/141a) to a movement speed of the corresponding elevator car (110) is about X:1 in the climbing process, X is larger than or equal to 2;
and the ropes (130) for each of said plurality of elevator cars (110) does not interfere with other ropes (130) for other elevator cars (110).

37. The rope climbing elevator system (10,20,30,40,50,60,30,40,50,60,70,80,90) of claim 36, wherein each of the one or more ropes (130) for each of said plurality of elevator cars (110) wraps partially around the one or more host upper diverter pulleys (120), extends downward and wrap partially around a low portion of the first drive pulley (141a/141b), extends continually and wrap partially around a top portion of the second drive pulley (141b/141a), and extends downward and wrap partially around the one or more host lower diverter pulleys (150);
for each of said plurality of elevator cars (110), fixing manners of a first end (131) and a second end (132) of each of the one or more ropes (130) with respect to the elevator car (110) and/or arrangement of a part of ropes (130) between the first end (131) and the host upper diverter pulleys (120) and a part of ropes (130) between the second end (132) and the host lower diverter pulleys (150) are arranged in certain manner such that a ratio of a linear speed of the host upper diverter pulleys (120) and host lower diverter pulleys (150) to the movement speed of the corresponding elevator car (110) is about (X−1):1 in the climbing process.

38. The rope climbing elevator system (10,20,30,40,50,60,30,40,50,60,70,80,90) of claim 37, wherein a first end (131) and a second end (132) of each of the one or more ropes (130) for each of said plurality of elevator cars (110) are fixed with respect to the each of said plurality of elevator cars (110), and each of the one or more ropes (130) for each of said plurality of elevator cars (110) is arranged to:
firstly extend upward from the first end (131) and wrap partially around the one or more host upper diverter pulleys (120), extend downward and wrap partially around a low portion of the first drive pulley (141a/141b), extend continually and wrap partially around a top portion of the second drive pulley (141b/141a), extend downward and wrap partially around the one or more host lower diverter pulleys (150), and finally extend upward to the second end (132);
and the ropes (130) for each of said plurality of elevator cars (110) does not interfere with other ropes (130) for other elevator cars (110).

39. The rope climbing elevator system (10,20,30,40,50,60,30,40,50,60,70,80,90) of claim 36, wherein the paired drive pulley (141) for each of said plurality of elevator cars (110) is arranged to be staggered with the paired drive pulley (141) for another of said plurality of elevator cars (110), such that the ropes (130) for each of said plurality of elevator cars (110) neither interferes with another ropes (130) for another of said plurality of elevator cars (110), nor interferes with another of said plurality of elevator cars (110).

40. The rope climbing elevator system (10,20,30,40,50,60,30,40,50,60,70,80,90) of claim 39, wherein the paired drive pulley (141) for each of said plurality of elevator cars (110) and another paired drive pulley (141) for another of the elevator cars (110) are in parallel in a left-right direction and are staggered with each other in a front-back direction perpendicular to the left-right direction.

41. The elevator system (10,20,30,40,50,60,30,40,50,60,70,80,90) of claim 40, wherein each of said plurality of elevator cars (110) is provided with a propulsion device (140), which comprises the paired drive pulley (141) and a drive motor for driving the first drive pulley (141a/141b) and the second drive pulley (141b/141a) to rotate in opposite directions;
wherein the propulsion device (140) is integrally fixed above top or below bottom of each of said plurality of elevator cars (110).

42. The elevator system (10,20,30,40,50,60,30,40,50,60,70,80,90) of claim 41, wherein the propulsion device (140) has a first protrusion portion (142a) and a second protrusion portion (142b) that are arranged to protrude toward a first side and a second side with respect to each of said plurality of elevator cars (110) respectively;
the host upper diverter pulleys (120) comprises a first host upper diverter pulley (120a) that is arranged to correspond to the first protrusion portion of the propulsion device (140) in the up-down direction and a second host upper diverter pulley (120b) that is arranged to correspond to the second protrusion portion (142b) of the propulsion device (140) in the up-down direction;
the host lower diverter pulleys (150) comprises a first host lower diverter pulley (150a) that is arranged to correspond to the first protrusion portion (142a) of the propulsion device (140) in the up-down direction and a second host lower diverter pulley (150b) that is arranged to correspond to the second protrusion portion (142b) of the propulsion device (140) in the up-down direction;
the ropes (130) comprise a first rope (130a) and a second rope (130b).

43. The elevator system (10,20,30,40,50,60,30,40,50,60,70,80,90) of claim 42, wherein the first rope (130a) is arranged in such a manner that the first end (131) of the first rope (130a) is fixed to the first protrusion portion (142a) of the propulsion device (140), extends upward and wraps partially around the first host upper diverter pulley (120a), extends downward and wraps partially around the low portion of the first drive pulley (141a/141b), extends continually and wraps partially around the top portion of the second drive pulley (141b/141a), extends downward and wraps partially around the second host lower diverter pulley (150b), and finally extends upward to the second end (132) of the first rope (130a), the second end (132) of the first rope (130a) being fixed to the second protrusion portion (142b) of the propulsion device (140);
wherein the second rope (130b) is arranged in such a manner that the first end (131) of the second rope (130b) is fixed to the second protrusion portion (142b) of the propulsion device (140), extends upward and wraps partially around the second host upper diverter pulley (120b), extends downward and wraps partially around the low portion of the second drive pulley (141b/141a), extends continually and wraps partially around the top portion of the first drive pulley (141a/141b), extends downward and wraps partially around the first host lower diverter pulley (150a), and finally extends upward to the second end (132) of the second rope (130b), the second end (132) of the second rope (130b) being fixed to the first protrusion portion (142a) of the propulsion device (140).

44. The elevator system (10,20,30,40,50,60,30,40,50,60,70,80,90) of claim 39, wherein the paired drive pulley (141) for each of said plurality of elevator cars (110) and another paired drive pulley (141) for another of said plurality of elevator cars (110), when vertically mapped on a bottom plane of the shaft, are interlaced with each other.

45. The elevator system (10,20,30,40,50,60,30,40,50,60,70,80,90) of claim 44, wherein each of said plurality of elevator cars (110) is provided with the first host upper diverter pulley (120a), the second host upper diverter pulley (120b), the first host lower diverter pulley (150a) and the second host lower diverter pulley (150b) that are arranged substantially in a front-back direction perpendicular to the left-right direction respectively.

46. The elevator system (10,20,30,40,50,60,30,40,50,60,70,80,90) of claim 36, wherein each of said plurality of elevator cars (110) is further provided with:
one or more first middle diverter pulleys (171a, 171b) and one or more second middle diverter pulleys (172a, 172b), which are fixed with respect to the corresponding elevator car (110) and move along the up-down direction in sync with the corresponding elevator car (110) in the climbing process;
wherein the first middle diverter pulleys (171a, 171b) are arranged with opposite to the host upper diverter pulleys (120), the second middle diverter pulleys (172a, 172b) are arranged with opposite to the host lower diverter pulleys (150).

47. The elevator system (10,20,30,40,50,60,30,40,50,60,70,80,90) of claim 46, wherein X is and odd number lager than or equal to 3; for each of said plurality of elevator cars (110), a first end (131) and a second end (132) of each of the one or more ropes (130) are fixed above the first middle diverter pulleys (171a, 171b) and below the second middle diverter pulleys (172a, 172b) respectively, and are immobile in the up-down direction in the climbing process;
each of the one or more ropes (130) for each of said plurality of elevator cars (110) is arranged to:
firstly extend downward from the first end (131) and warp partially around the first middle diverter pulleys (171a, 171b), extend upward and wrap partially around the one or more host upper diverter pulleys (120), extend downward and wrap partially around a low portion of the first drive pulley (141a/141b), extend continually and wrap partially around a top portion of the second drive pulley (141b/141a), extend downward and wrap partially around the one or more host lower diverter pulleys (150), extend upward and wrap partially around the second middle diverter pulleys (172a, 172b), and finally extend downward to the second end (132).

48. The elevator system (10,20,30,40,50,60,30,40,50,60,70,80,90) of claim 46, wherein X is and even number lager than or equal to 4; each of said plurality of elevator cars (110) is further provided with:
one or more slave upper diverter pulleys (120′), which are fixedly arranged above the elevator car (110); and
one or more slave lower diverter pulleys (150′), which are fixed to the tensioners (160;
wherein a first end (131) and a second end (132) of each of the one or more ropes (130) are fixed with respect to the elevator car (110) and each of the one or more ropes (130) is arranged to:
firstly extend upward from the first end (131) and wrap partially around slave upper diverter pulleys (120′), extend downward and wrap partially around the first middle diverter pulleys (171a, 171b), extend upward and wrap partially around the one or more host upper diverter pulleys (120), extend downward and wrap partially around a low portion of the first drive pulley (141a/141b), extend continually and wrap partially around a top portion of the second drive pulley (141b/141a), extend downward and wrap partially around the one or more host lower diverter pulleys (150), extend upward and wrap partially around the second middle diverter pulleys (172a, 172b), extend downward and wrap partially around slave lower diverter pulleys (150′), and finally extend upward to the second end (132).
